(19) United States
(12) Patent Application Publication
(10) Pub. No.: US 2010/0138227 A1
(43) Pub. Date: Jun. 3, 2010

(54) SYSTEM AND METHOD TO DYNAMICALLY PLACE PRODUCTS IN A VIRTUAL UNIVERSE

(75) Inventors: Alfred J. BRIGNULL, Essex Junction, VT (US); Michele P. BRIGNULL, Essex Junction, VT (US); Rick A. HAMILTON, II, Charlottesville, VA (US); Anne R. SAND, Peyton, CO (US); James W. SEAMAN, Falls Church, VA (US)

Correspondence Address: ROBERTS MLOTKOWSKI SAFRAN & COLE, P.C.;Intellectual Property Department, P.O. Box 10064, MCLEAN, VA, 22102-8064, US

(73) Assignee: INTERNATIONAL BUSINESS MACHINES CORPORATION, Armonk, NY (US)

(21) Appl. No.: 12/325,471

(22) Filed: Dec. 1, 2008

(51) Int. Cl. G06Q 99/00

(52) U.S. Cl. 705/1.1

(57) ABSTRACT

A system and method is provided to dynamically place products in a virtual universe and, in particular, to dynamically place products in a virtual universe based on an entity's budget. The system includes a placement location analysis engine configured to identify at least one location within a virtual universe and a placement cost analysis engine configured to determine a cost for displaying one or more items at one or more of the at least one location. The system also includes a recommendation engine configured to recommend one or more of the at least one location based on a budget.

### FIELD OF THE INVENTION

The invention generally relates to a system and method to dynamically place products in a virtual universe and, in particular, to dynamically place products in a virtual universe based on an entity's budget.

### BACKGROUND OF THE INVENTION

A virtual universe (VU) is an interactive simulated environment accessed by multiple users through an online interface. Users inhabit and interact in the VU via avatars, which are a user's representation of himself or herself. These representations can be in the form of a three-dimensional model, a two-dimensional icon, a text construct, a user screen name, etc. Although there are many different types of VUs, there are several features many VUs generally have in common. These features include, for example,
Shared Space: the VU allows many users to participate at once;
Graphical User Interface: the VU depicts space visually, ranging in style from 2D “cartoon” imagery to more immersive 3D environments;
Immediacy: interaction takes place in real time;
Interactivity: the VU allows users to alter, develop, build, or submit customized content;
Persistence: the VU's existence continues regardless of whether individual users are logged in; and
Socialization/Community: the VU allows and encourages the formation of social groups such as teams, guilds, clubs, cliques, housemates, neighborhoods, etc.

A benefit of VUs is that they allow users to easily test new ideas, develop marketing strategies, and gain business experience in a simulated real world environment. Among the experiences gained by users, and vendors in particular, is how to create a budget and how best to use the budget to place products where they can reach potential customers.

### SUMMARY OF THE INVENTION

In a first aspect of the invention, a system comprises a placement location analysis engine configured to identify at least one location within a virtual universe. The system further comprises a placement cost analysis engine configured to determine a cost for displaying one or more items at one or more of the at least one location. Additionally, the system comprises a recommendation engine configured to recommend one or more of the at least one location based on a budget.

In another aspect of the invention, the method comprises ascertaining a cost associated with displaying at least one item at one or more locations. The method further comprises relaying information about the cost to a user, thereby allowing the user to select at least one of the one or more locations that fit the user's budget.

In another aspect of the invention, a computer program product comprising a computer usable medium having readable program code embodied in the medium is provided. The computer program product includes at least one component to: determine a cost for displaying one or more items at one or more of at least one location; and recommend one or more of the at least one location based on a user's budget.

In another aspect of the invention, a method for deploying an application for placing items in a virtual universe, comprises: providing a computer infrastructure being operable to: determine at least one location available in a virtual universe for rent, lease, sub-let, assignment, or purchase; ascertain a cost for renting, leasing, sub-letting, assigning, or purchasing the at least one location; and suggest one or more of the at least one location to a user based on a user's budget.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 shows an illustrative environment for implementing the steps in accordance with the invention;

FIG. 2 is a flow chart of steps for implementing aspects of the invention;

FIG. 3 shows exemplary embodiments according to aspects of the invention; and

FIG. 4 illustrates a dynamically subdivided location in accordance with the invention.

### DETAILED DESCRIPTION OF THE INVENTION

The invention is directed to a system and method to dynamically place products in a VU and, in particular, to dynamically placing products in a virtual universe based on an entity's budget. Currently, new and experienced users within a VU have problems finding locations to place their products to optimally reach customers. Part of this problem is due to how time consuming it is to research locations, determine whether a location is suitable for a target demographic, determine the amount of space required, how much the space will cost, how long to display the product, etc. These problems are compounded when one or more factors relating to a vendor's budget are changed while searching for a location or after a location has been found.

The present invention is configured to determine what locations are available for purchase, rent, lease, sublease, etc. The available locations are then narrowed down based on one or more factors that have been input by the vendor. These factors may relate to the amount of space required to display the vendor's products, the duration the location is needed for, the popularity of the products to be displayed, etc. The cost for displaying a product at one or more of the possible locations can then be calculated and compared to a vendor's budget. Those locations that fit within a vendor's budget can be recommended to the vendor. The recommendations can be used by the vendor to find, e.g., the most expensive locations within the advertiser's budget.

Additionally, the present invention allows one or more of the vendor inputs to be changed and new recommendations to be dynamically suggested based on the changes. These inputs may be changed automatically or manually by the vendor. For example, the inputs can be automatically changed to produce another set of recommendations, which can be presented at the same time or a different time than the original recommendations. These altered recommendations allow the vendor to view locations that may be just outside of the vendor's budget. The vendor can use this information to negotiate with location owners to decrease purchase prices, leasing costs, durations, etc.

The present invention also allows product placement locations to be dynamically subdivided and recommended to the vendors. For example, suppose a vendor finds an ideal location to display products, however, the vendor does not have a large enough product line to fill the location. The present invention allows the vendor to sublet all or part of a location to another vendor to recoup costs associated with purchasing, renting, leasing, etc., the location. The amount of space available can be dynamically calculated and/or listed by the vendor. The amount charged for the space can be determined using an evaluation tool and/or determined by the vendor.

It should be understood that while the present invention can be used to recommend locations and dynamically place products in a VU, the invention can also be used in the real world.

In addition to problems encountered by vendors, location owners also have problems when evaluating and trying to sell, lease, or rent their locations. Some of these problems occur because of difficulties involved in promoting available locations. Additional problems can occur because of the size of the location, the price of the location, the duration of time the location is available, etc. For example, a user may own and desire to lease a large location to a global vendor. However if the location is too large the vendor may be deterred from leasing the location. This may occur, e.g., because the vendor may not have enough products to fill the location, may only need the location for a portion of the time in which the location is being offered, etc. Also, location owners want to maximize their profit when selling, leasing, or renting locations. However, this desire frequently runs counter to the vendor's objective of keeping within a budget. Currently there exists no way to dynamically balance the location owner's interests with the vendor's interests to determine an optimal solution that benefits the location owner and fits within the vendor's budget. The present invention overcomes these problems.

### System Environment

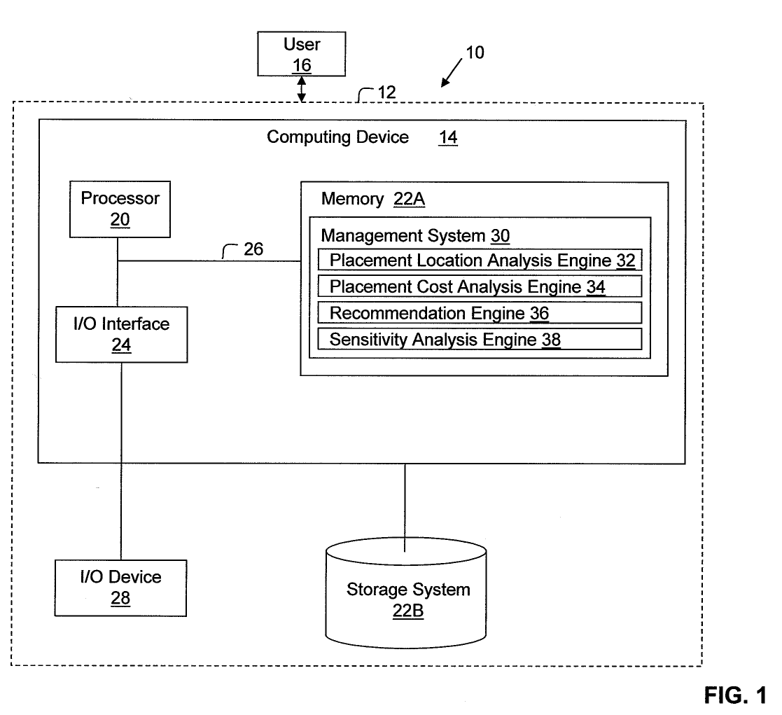

FIG. 1 shows an illustrative environment 10 for managing the processes in accordance with the invention. To this extent, the environment 10 includes a server 12 that can perform the processes described herein. In particular, the server 12 includes a computing device 14, which may be in the form of a VU server system. The computing device 14 comprises a Management System 30, which may be embodied as a VU and stored in memory 22A. The Management System 30 includes a Placement Location Analysis Engine 32, a Placement Cost Analysis Engine 34, a Sensitivity Analysis Engine 38, and a Recommendation Engine 36.

More specifically, the Placement Location Analysis Engine 32 is configured to make computing device 14 operable to identify available locations within a VU. These locations may be available to rent, lease, own, etc. Additionally, the Placement Location Analysis Engine 32 can identify locations that are available to be sub-let from a current lessee. For example, the Placement Location Analysis Engine 32 can identify locations that are being leased and ask the current lessee if the lessee desires to sublease all or part of the location. Embodiments may make a determination as to whether the lessee has space within the location available prior to inquiring whether the lessee would like to sublet all or part of the location. Additionally, embodiments may allow the lessee to proactively identify a location available to be sublet. By permitting lessees to sublease an entire location, or part of a location, dynamic subdivisions of locations within a VU can be created.

Once the Placement Location Analysis Engine 32 identifies locations available for purchasing, renting, leasing, subleasing, etc., an evaluation of the value of the location can be determined. This evaluation can be performed by the Placement Location Analysis Engine 32. However, embodiments may perform this evaluation using a designated evaluation engine or a different engine within the Management System 30, such as the Placement Cost Analysis Engine 34. The evaluation can be based on a location owners assessment of the location, pricings of nearby locations, pricings of locations used for similar purposes, and/or independent assessments from a third party, etc.

The Placement Cost Analysis Engine 34 is configured to make computing device 14 operable to determine a cost associated with displaying one or more products at a location that have been identified by the Placement Location Analysis Engine 32. When determining the cost of a product placement, the vendor may be asked to input information about the product and location requirements or restrictions. These inputs may include information regarding the: number of items to be displayed by the vendor; size of the product to be displayed; quantity of the product offered; duration of the display; desired placement of the products within the location; popularity or product turnover of the items to be displayed; proximity of the item to other items; additional display requirements for posters, signs, demos, etc., relating to the vendor and/or displayed product; seasonal considerations; desired customer demographics; etc. Embodiments may weigh each input factor equally, unequally according to a predetermined criteria, or allow the user to weigh one or more of the inputs. Embodiments may obtain some or all of this information from the vendor by scanning information associated with the vendor and/or by scanning the vendor's previous inputs, etc. Once the inputs are obtained, and optionally weighed, a determination can be made as to what locations are available given the inputs and how much each location costs.

The Recommendation Engine 36 is configured to make computing device 14 operable to recommend one or more locations to the vendor in which to display one or more of the vendor's products. In making a recommendation, the Recommendation Engine 36 obtains information about the vendor's budget and utilizes information obtained from the Placement Cost Analysis Engine 34, and optionally the Sensitivity Analysis Engine 38, to determine which locations meet the vendor's location requirements and budgetary constraints.

For example, the Recommendation Engine 36 can obtain information from the Placement Cost Analysis Engine 34 to determine the cost associated with the product placement and compare the product placement cost to the vendor's budgetary constraints. Those locations that exceed the vendor's budget for a product and/or for a portfolio of products can be eliminated. The Recommendation Engine 36 can make recommendations by calculating the cost per product or for an entire portfolio of products. Recommendations can also be made by calculating the cost for displaying the vendor's products at a optimum location, at non-optimum locations, or at a plurality of locations.

The Recommendation Engine 36 can present the calculated recommendations as a list of option packages, whereby each option package contains recommendations on what locations, and spaces within a location, a product can be placed to optimize the vendor's budget. Embodiments may allow a vendor to select a whole package, portions from one or more packages, and/or add new product placement locations.

The Recommendation Engine 36 is beneficial for vendors and location owners. For example, in embodiments, the Recommendation Engine 36 is beneficial for location owners because it recommends the most expensive display locations within each vendor's budget. This allows location owners to promote prime locations and/or prime spaces within a location to vendors, thereby increasing revenue. Additionally, this allows vendors to set a budget and be presented with the best locations and spaces within a location to place products, thereby effectively maximizing a vendor's budget.

The Sensitivity Analysis Engine 38 is configured to make computing device 14 operable to run scenarios based on the vendor's inputs, variations in a vendor's budget, altered location preferences, etc. For example, the Sensitivity Analysis Engine 38 can run a scenario wherein the vendor has: a higher budget; more or fewer products; different budget allocations for one or more of the vendor's products; different location preferences, such as displaying a product at the back of a location instead of the front of the location; etc.

This information can be used by the Recommendation Engine 36 to rerun calculations and to recommend next-best locations, different pricing allocations, etc. In doing so, a vendor can observe what locations fit within the vendor's budgetary constraints, what locations fall just outside of the vendor's budgetary constraints, and what locations are optimal when one or more of the vendor's inputs are altered. This allows the vendor to negotiate with location owners or lessee's to obtain lower costs for product placements.

It should be understood that the Sensitivity Analysis Engine 38 may be utilized after the Recommendation Engine 36 has made recommendations to a vendor. However, embodiments may utilize the Sensitivity Analysis Engine 38 prior to the Recommendation Engine 36 such that additional scenarios are presented to the vendor along with the calculated recommendations. This allows vendors to obtain a list of recommended locations and redo the analysis based on new or altered budgetary constraints and/or input values.

Once a vendor selects one or more of the recommendations from the Recommendation Engine 38, the products can be automatically generated and displayed at the location via an I/O device 28. The product generation may be performed by the management system, by a designated display system, and/or any system within a VU designed to handle product generation and display.

While the Management System 30 includes multiple engines, it should be understood by those skilled in the art that additional engines may also be included in the Management System 30. For example, an engine may be included to compute which recommendations should be given to the vendor via the Recommendation Engine 36. Additionally, an engine may be included to automatically generate products in a location or space once the vendor has decided where to display the products.

Still referring to FIG. 1, the computing device 14 includes a processor 20, the memory 22A, an input/output (I/O) interface 24, and a bus 26. The memory 22A can include local memory employed during actual execution of program code, bulk storage, and cache memories which provide temporary storage of at least some program code in order to reduce the number of times code must be retrieved from bulk storage during execution. For example, the memory can provide local memory employed during execution of the program codes for engines 32, 34, 36, and 38.

Further, the computing device 14 is in communication with an external I/O device/resource 28 and the storage system 22B. For example, the I/O device 28 can comprise any device that enables an individual to interact with the computing device 14 or any device that enables the computing device 14 to communicate with one or more other computing devices using any type of communications link. The external I/O device/resource 28 may be keyboards, displays, pointing devices, etc.

In general, the processor 20 executes computer program code, which is stored in the memory 22A and/or storage system 22B. While executing computer program code, the processor 20 can read and/or write data to/from memory 22A, storage system 22B, and/or I/O interface 24. The program code can execute the processes described herein. The bus 26 provides a communications link between each of the components in the computing device 14.

The computing device 14 can comprise any general purpose computing article of manufacture capable of executing computer program code installed thereon (e.g., a personal computer, server, handheld device, etc.). However, it is understood that the computing device 14 is only representative of various possible equivalent computing devices that may perform the processes described herein. To this extent, in embodiments, the functionality provided by the computing device 14 can be implemented by a computing article of manufacture that includes any combination of general and/or specific purpose hardware and/or computer program code. In each embodiment, the program code and hardware can be created using standard programming and engineering techniques, respectively.

Similarly, the server 12 is only illustrative of various types of computer infrastructures for implementing the invention. For example, in embodiments, the server 12 comprises two or more computing devices (e.g., a server cluster) that communicate over any type of communications link, such as a network, a shared memory, or the like, to perform the process described herein. Further, while performing the processes described herein, one or more computing devices on the server 12 can communicate with one or more other computing devices external to the server 12 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols.

In embodiments, the invention provides a business method that performs the steps of the invention on a subscription, advertising, and/or fee basis. That is, a service provider, such as a Solution Integrator, could offer to perform the processes described herein. In this case, the service provider can create, maintain, deploy, support, etc., the computer infrastructure that performs the process steps of the invention for one or more customers. In return, the service provider can receive payment from the customer(s) under a subscription and/or fee agreement and/or the service provider can receive payment from the sale of advertising content to one or more third parties.

### Exemplary Implementation of the System of the Invention

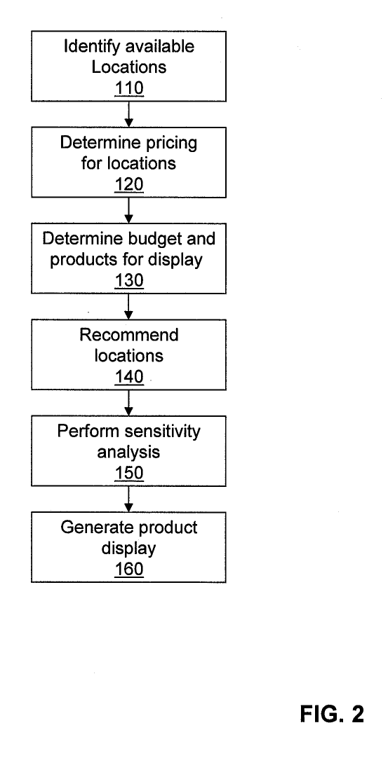

FIG. 2 is flow diagram implementing steps of the invention, which may be implemented in the environment of FIG. 1. FIG. 2 may equally represent a high-level block diagram of the invention. The steps of FIG. 2 may be implemented and executed from either a server, in a client server relationship, or they may run on a user workstation (which can be generally represented in FIG. 1) with operative information conveyed to the user workstation to allow information to be presented to a user during content breakpoints. Additionally, the invention can take the form of an entirely hardware embodiment, an entirely software embodiment or an embodiment containing both hardware and software elements.

In an embodiment, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system. The software and/or computer program product can be implemented in the environment of FIG. 1, as should be understood and capable of implementation by those of skill in the art. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

FIG. 2 illustrates steps for implementing aspects of the present invention. The process begins by identifying one or more available locations in a VU to display products, at step 110. This may be done via the Placement Location Analysis Engine, which determines what locations and/or spaces are available for rent, lease, sublease, purchase, etc.

Once available locations are ascertained, the cost for renting, leasing, subleasing, owning, etc., a location or a space within a location can be established, at step 120. This may be done via the Placement Cost Analysis Engine, which allows a user to input a number of factors relating to the vendor's budget and the products in the vendor's portfolio. These factors can be used to determine what locations should be recommended to the vendor so as to mutually benefit the vendor and the location owner.

For example, the vendor may be asked to input information about the size of the product and/or the number of items to be displayed. This information allows the Placement Cost Analysis Engine, or other computing engine, to narrow the list of possible locations to those that have enough space to display the products. Additional space requirements, and the costs associated with the additional space requirements, may also be considered. For example, a vendor may need additional space to display posters, signs, demos, etc. This additional space may or may not require additional monetary expenditures.

Embodiments may also request from the vendor what date the vendor wants to start and/or stop displaying the products, how long of a duration the vendor is planning to display the products, etc. This information allows the Placement Cost Analysis Engine, or other computing engine, to narrow the list of possible locations to those that are available during the time period specified by the user. Embodiments of the invention may also list locations that extend before and/or after the specified time period.

Further, embodiments may request from the vendor input as to the quantity of products to be offered. For example, if the vendor has a limited quantity or stock of a product being offered for sale then the amount of time the vendor needs to place products in a location or space may be highly variable. Information on the quantity of products offered can also be used by the Placement Location Analysis Engine to dynamically determine when a vendor is getting low on products to sell and therefore have an excess of space that may be available for another vendor to sublet.

Information about the vendor's placement of products within a location and/or how close the vendor wants the products to be to one or more other products can also be obtained, at step 130. For example, if a vendor has a popular product and/or wants to display a product next to a popular product, then the Placement Cost Analysis Engine, or other computing engine, can use these inputs to determine what locations are available that meet this desired criteria. Additional considerations, such as the time of year the product is being offered, may also be input by the vendor or calculated by the Placement Cost Analysis Engine.

Embodiments may also ask for additional input such as what locations the vendor prefers, whether the vendor is interested in subleasing a location or space within a location, what demographics the vendor wants to target, and/or what demographics the vendor wants to avoid. By inputting this information, vendors can try to reach target demographics and avoid locations where the vendor's products are not likely to sell as well. For example, a software producer may want to sell licenses for a new software product. Since the software is being licensed, the software producer may not want to display the software in a location where the vast majority of users design, use, and/or promote open source software. Thus, vendor input relating to customer demographics can affect which locations are recommended to the vendor.

Once one or more of these factors are inputted, the Placement Cost Analysis Engine can analyze what locations provided by the Placement Location Analysis Engine are available for the vendor to rent, lease, etc. Additionally, the Placement Cost Analysis Engine can determine how much each location costs. The costs for a location may be a set rate or a variable rate. For example, the costs could vary based on the location, the space within a location, the time of year, etc. If rates are variable then the rates for a certain space at a certain time can be listed by the location owner or calculated by the Placement Location Analysis Engine. The cost of a location may also be established via an auction, wherein location owners offer an auction price for a location or space within the location and vendors make bids for the location or space. An auction can beneficially allow a vendor to select an amount to bid by inputting potential display costs, calculating total costs associated with the vendor's needs, and comparing these amounts to the vendor's budgetary constraints.

Once available locations are determined, and vendor inputs on the products are entered, the Recommendation Engine determines what the vendor's budget is and recommends locations to the vendor, at step 140. The recommendation can be determined in a number of ways. In embodiments, for example, each input can be automatically weighted and/or weighted by the vendor. Embodiments may then determine how closely one or more of the locations meet the input information from the vendor. This determination can be a numerical value ranging between two numbers or Boolean. This numerical value is representative of how close a match the location is given the vendor's input values. For example, if a vendor wants to advertise Christmas products in November and December then a location available from November through January will be more beneficial and have a higher value than a location available from July until December. However, embodiments may be used to determine the likelihood that the location available from July until December can be sublet, e.g., from July until November. This information can then be used when determining how close of a match the location is to the vendor's inputs.

For example, in embodiments, the degree of closeness for an input at a given location can be multiplied by the weight associated with the input to obtain a value. The values for each input can be added to obtain a score, which represents how close of a fit the location is for a vendor's product given the vendor's weighing preferences. Each score can be independently considered and/or the scores can be combined in the case of a portfolio having multiple products. The results can then be recommended to the vendor to accept or reject.

In further embodiments, locations may be given a priority rating, which may be used to recommend a location to a vendor. For example, if multiple locations fit within a vendor's budget, a priority rating may be given to one or more of the locations to help the Recommendation Engine determine which location(s) to recommend to the vendor. The priority rating may be given to one or more location owners based on, for example, how frequently the location owner offers a location to vendors or whether the location owner has paid for a priority rating.

A sensitivity analysis can be performed by the Sensitivity Analysis Engine, at step 150. The Sensitivity Analysis Engine is configured to run and/or rerun scenarios based on variations in input values and budgetary constraints. For example, the Sensitivity Analysis Engine can be used to run scenarios that illustrate how the locations would differ if the vendor decided to start displaying the product at an earlier or later date, in a bigger or smaller location, at a more expensive location, at a different space in the location, etc. The various scenarios can then be presented to the vendor to accept, reject, or get additional information on.

Once the vendor selects one or more locations to display the vendor's products, the products can automatically be generated in the display location(s) selected by the vendor, at step 160. The generation of the display can be performed via a designated or generic display engine. The display engine can also be used to adjust the display after one or more products have been purchased as well as remove the display after the vendor's rental, lease, sublease, etc., has ended.

### Placement Cost Analysis Engine

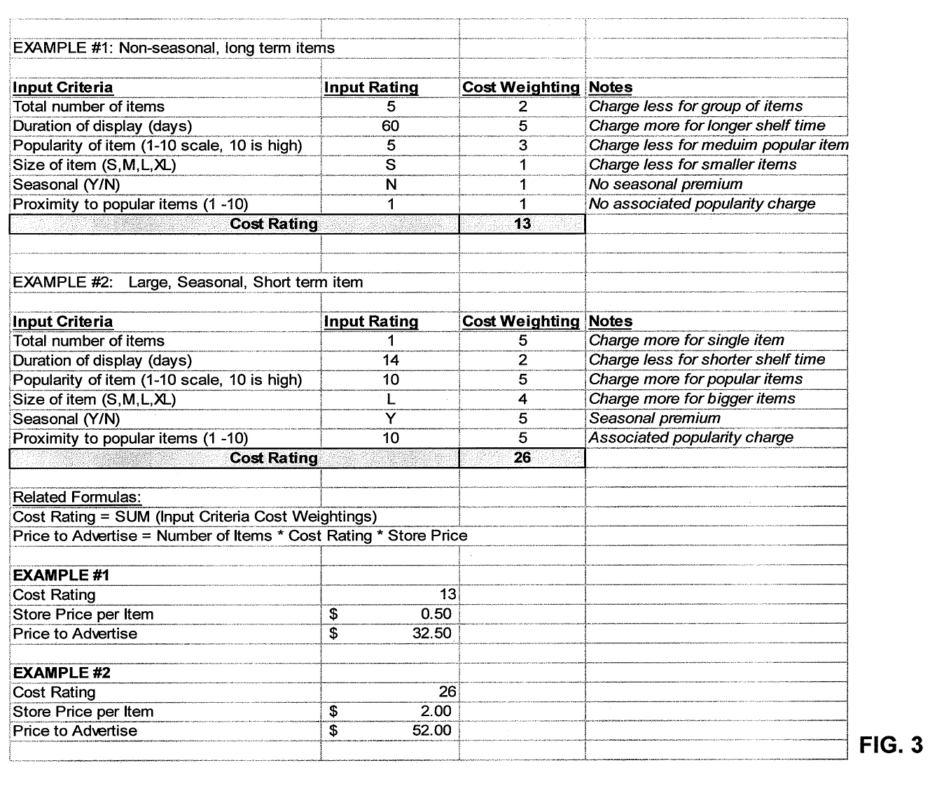

FIG. 3 shows an illustrative example of how product placement costs may be determined according to embodiments of the invention. In particular, FIG. 3 provides two illustrative examples of how product placement costs can be calculated by the Placement Cost Analysis Engine. These examples allow a vendor to rate a number of inputs, which are related to displaying one or more products. These inputs can include, for example: the number of items being displayed; the duration of the display; the popularity of the item; the size of the item; whether the item is seasonal; and the proximity of the item to popular items; etc. The vendor rating assigned to each of these inputs can be numerical, alphabetical, and/or alpha-numeric.

Embodiments may determine a cost weighting based on the vendor's input ratings. The cost weighting is related to how much the vendor is charged for displaying an item. The cost weighting may be determined in any number of ways. For example, a specific cost weighting may be assigned to all input ratings between a certain range. Thus, a vendor wanting to display four or five products may be assigned a first cost weighting while a vendor wanting to display eight or nine products may be assigned a second cost weighting.

Embodiments may determine a cost weighting in a number of additional ways. For example, embodiments may determine a cost weighting for each individual input rating. Further embodiments may assign a specific cost weighting to all input ratings having a specified input rating. For example, a specific cost weighting may be applied to all seasonal products and another cost weighting may be applied to all non-seasonal products.

Cost weighting may be related to economic trends. For example, a lower cost weighting may be applied to encourage vendors to display a larger number of products at one time. A lower cost weighting may also be applied to popular products because they may be more likely to attract consumers, additional vendors, and result in high product turnovers.

Cost weightings may also vary based on the size of the product. For example, if a product takes up a lot of space and/or can only be displayed in certain areas then a higher cost weighting may be applied. Additionally, cost weightings may vary based on the duration of a display. For example, a high cost weighting may be applied to long durational displays to encourage product turnover. However, it should be understood that cost weightings may vary between embodiments and the relationship between the input ratings and the cost weightings may fluctuate and/or be inverted in embodiments.

A cost rating can be determined based on one or more cost weightings. For example, the cost rating can be the sum of one or more cost weightings. However, the cost rating can alternatively be an algorithmic weighting of one or more of the cost weightings.

Once the cost rating is determined, it can be multiplied by the number of items being displayed and the price charged by a location owner to display each item. The price charged by a location owner may be set by the location owner, determined using an evaluation engine, etc. Embodiments may permit a location owner to specify multiple prices to be used when calculating a display cost. For example, a location owner may specify prices based on the type of purchase, lease, and/or rental agreement. The display price can be used by the Recommendation Engine when recommending one or more locations to a vendor.

### Dynamically Subdivided Locations

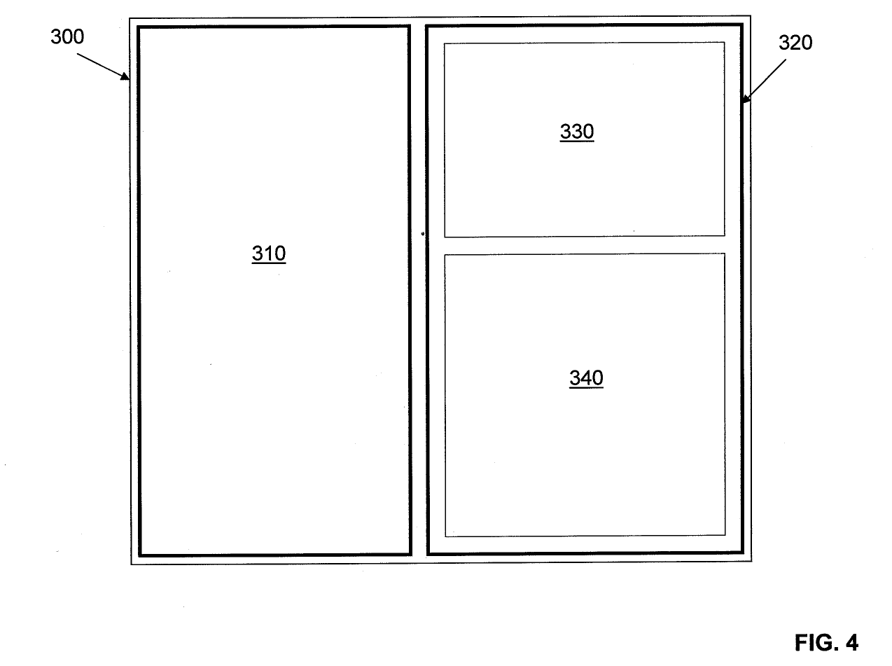

The present invention also allows locations to be dynamically subdivided into one or more locations, which are capable of being purchased, rented, leased, sub-let, etc. FIG. 4 is an exemplary illustration of how a location can be subdivided in accordance with the present invention. FIG. 4 includes a location 300 within a VU, which is owned by user A. User A can choose to lease the entire location 300 or any portion of the location to a vendor.

If user A decides to lease a portion of the location 300 then user A can let prospective lessees know about the available space by notifying the Placement Location Analysis Engine. Embodiments may ask user A one or more questions about the location 300, such as the cost of leasing the location 300, the duration of the lease, what portions of the location 300 is available to be leased, etc. The Placement Location Analysis Engine can use the information to help find possible lessees.

For example, user A may lease the location 300 to user B. However, the location 300 may be too large for user B. Therefore, user B may choose to split the location 300 into one or more locations 310 and 320. User B may, for example, keep location 310 and sub-let or assign location 320 to another user. User B may do this by notifying the Placement Location Analysis Engine about the available location 320. However, in embodiments, the Placement Location Analysis Engine may recognize that location 320 is not being used and contact user B about offering all or part of the location 320 for sub-let, assignment, etc.

User B can decide to sub-let or assign the unused part of the location 320 for an arbitrary amount, a percentage of the total cost of the location 300, or allow the Placement Location Analysis Engine to evaluate the location to determine the market rate for the location 320. Once the cost for the location 320 is determined, the location 320 can be offered for sub-let or assignment. Embodiments may allow the location 320 to be further broken down into one or more locations 330 and 340 by user B or by the Placement Location Analysis Engine. For example, the location 320 can be dynamically subdivided into one or more locations 330 and 340 to maximize the use of the location 320 and to allow the owner or lessee to recoup part of their investment and/or operating costs.

The dynamic subdivision of locations and leasing of the locations can be based solely off of supply and demand. For example, a location owner may lease the location to any user so long as the user pays the asking price. However, embodiments may allow the location owner to restrict who the location is leased to. For example, the location owner may require all sub-letters sell technology related products and/or services. This allows a number of technology products from multiple suppliers to be sold at a common location.

### ADDITIONAL EMBODIMENTS

While the invention has been described in terms leasing, sub-letting, purchasing, etc., it should be understood by those skilled in the art that any number of property transactions may occur using the present invention. For example, the present invention may permit vendors to assign all or part of a location to another vendor. Furthermore, while the invention has been described in terms of vendors, it should be understood that the present invention equally applies to all users, which includes vendors and non-vendors. Additionally, those skilled in the art should realize that the present invention can be applied in the real world in addition to a VU and any combination of the features can be provided by a service provider.

While the invention has been described in terms of embodiments, those skilled in the art will recognize that the invention can be practiced with modifications and in the spirit and scope of the appended claims. Additionally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if applicable, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Accordingly, while the invention has been described in terms of embodiments, those of skill in the art will recognize that the invention can be practiced with modifications and in the spirit and scope of the appended claims.

What is claimed is:

1. A system comprising:
a placement location analysis engine configured to identify at least one location within a virtual universe;
a placement cost analysis engine configured to determine a cost for displaying one or more items at one or more of the at least one location; and
a recommendation engine configured to recommend one or more of the at least one location based on a budget.

2. The system of claim 1, wherein the cost for displaying the one or more items is determined from one or more inputs, which include at least one of: a number of items to be displayed by a user; a size of the one or more items to be displayed; a quantity of the one or more items offered; a duration in which the one or more items is displayed; a desired placement of the one or more items within the at least one location; a popularity of the one or more items to be displayed; a proximity of the one or more items to other items; and additional display requirements for posters, signs, and/or demos.

3. The system of claim 2, further comprising a sensitivity analysis engine configured to provide additional scenarios by adjusting the one or more inputs and/or the budget.

4. The system of claim 1, wherein the recommendation engine recommends one or more of the at least one location that is most expensive and the at least one location based on the user's budget.

5. The system of claim 1, wherein the at least one location is configured to be dynamically partitioned into one or more additional locations.

6. The system of claim 5, wherein the one or more additional locations are configured to be rented, leased, sub-let, assigned, or purchased.

7. The system of claim 1, wherein the placement location analysis engine, the placement cost analysis engine, and the recommendation engine are implemented on a computer infrastructure and executed on computer program code embodied on the computer infrastructure.

8. A method implemented on a computing infrastructure for placing items in a virtual universe comprising:
ascertaining a cost associated with displaying at least one item at one or more locations; and
relaying information about the cost to a user, thereby allowing the user to select at least one of the one or more locations that fit a user's budget.

9. The method of claim 8, further comprising dynamically partitioning the one or more locations into one or more additional locations.

10. The method of claim 8, further comprising requesting leasing, sub-leasing, renting, assigning, and/or purchasing the one or more locations.

11. The method of claim 8, wherein the cost associated with displaying the at least one item is calculated from a cost rating and a price charged by a location owner.

12. The method of claim 8, further comprising generating a display of the at least one item at the selected at least one of the one or more locations.

13. The method of claim 8, wherein the steps of claim 8 are offered by a service provider based on one of a fee and subscription basis.

14. The method of claim 8, wherein the steps of claim 8 are provided on a computer infrastructure, which is one of supported, deployed, maintained, and created by a service provider.

15. The method of claim 8, comprising:
identifying the one or more locations that are available;
determining the one or more locations that are configured to display the at least one item;
ascertaining the cost associated with displaying the at least one item at each of the one or more locations;
comparing the cost associated with displaying the at least one item to the user's budget;
recommending at least one of the one or more locations that fit the user's budget to the user;
allowing the user to select at least one of the one or more locations that fit the user's budget; and
generating a product display comprising the one or more items.

16. A computer program product comprising a computer usable storage medium having readable program code embodied in the storage medium, the computer program product includes at least one component operable to:
determine a cost for displaying one or more items at one or more of at least one location; and
recommend one or more of the at least one location based on a user's budget.

17. The computer program product of claim 16, wherein the user selects one or more of the at least one location to display the one or more items.

18. The computer program product of claim 16, wherein the at least one location is configured to be dynamically partitioned into one or more additional locations.

19. The computer program product of claim 16, wherein the cost for displaying the one or more items is determined from one or more of: a number of items to be displayed by the user; a size of the one or more items to be displayed; a quantity of the one or more items offered; a duration in which the one or more items is displayed; a desired placement of the one or more items within the at least one location; a popularity of the one or more items to be displayed; a proximity of the one or more items to other items; and additional display requirements for posters, signs, and/or demos.

20. The computer program product of claim 16, wherein the computer infrastructure is at least one of supported, deployed, maintained, and created by a service provider.

21. The computer program product of claim 16, comprising at least one component operable to:
ascertain the at least one location configured to display the one or more items;
determine the cost associated with displaying the one or more items, wherein the cost is determined from one or more of a number of items to be displayed by the user; a size of the one or more items to be displayed; a quantity of the one or more items offered; a duration in which the one or more items is displayed; a desired placement of the one or more items within the at least one location; a popularity of the one or more items to be displayed; a proximity of the one or more items to other items; and additional display requirements for posters, signs, and/or demos;
comparing the cost associated with displaying the at least one item to the user's budget;
recommending one or more of the at least one location that fits the user's budget;
allowing the user to select one or more of the at least one location that fits the user's budget; and
generating a product display comprising the one or more items.

22. A method for deploying an application for placing items in a virtual universe, comprising:
providing a computer infrastructure being operable to:
determine at least one location available in a virtual universe for rent, lease, sub-let, assignment, or purchase;
ascertain a cost for renting, leasing, sub-letting, assigning, or purchasing the at least one location; and
suggest one or more of the at least one location to a user based on a user's budget.

23. The method of claim 22, wherein the at least one location is configured to be dynamically partitioned into one or more additional locations.

24. The method of claim 22, wherein one or more items are dynamically generated at the at least one location.

25. The method of claim 22, wherein the computer infrastructure is at least one of supported, deployed, and created by a service provider.
